(19) United States
(12) Patent Application Publication
(10) Pub. No.: US 2003/0082386 A1
(43) Pub. Date: May 1, 2003

(54) Coating layer on a curable rubber layer and method for forming

(76) Inventors: John K. Hussey, Burnt Hills, NY (US); James C. Hussey, Ballston Spa, NY (US); Nod J. Reo, Saratoga Springs, NY (US)

Correspondence Address: ARLEN L. OLSEN, SCHMEISER, OLSEN & WATTS, 3 LEAR JET LANE, SUITE 201, LATHAM, NY, 12110, US

(21) Appl. No.: 10/037,264

(22) Filed: Oct. 29, 2001

(51) Int. Cl. B32B 27/00

(52) U.S. Cl. 428/421; 428/450; 428/447

(57) ABSTRACT

A chemically resistant coating layer chemically bonded to a curable rubber layer is disclosed. The curable rubber layer material may be any silicone elastomer, organic elastomer, viton, sanoprene, or EPDM. The coating layer material may be polytetrafluoroethylene (PTFE) sheet or the like that will protect the curable rubber layer from solvents such as toluene, acetone, or other chemicals by reducing or preventing permeation of such solvents or chemicals through the coating layer material. Covers made from the chemically resistant coating layer chemically bonded to the curable rubber layer may be used for vial covers, septa and container covers for use as covers for containers that hold chemical samples for biotechnological, chemical or medicinal experiments or chemical analysis. In addition, the coating layer on a rubber layer may be an automotive windshield wiper blade or any laminated article having a coating layer on a curable rubber layer.

### BACKGROUND OF THE INVENTION

1. Technical Field

This invention relates generally to an apparatus having an operable surface, wherein the operable surface is a coating layer chemically bonded to a heat curable rubber, and methods for forming the operable surface on the apparatus. More particularly, forming the operable surface on the apparatus by chemically bonding the coating layer to the curable rubber layer results in the apparatus having, for example, a reduced coefficient of friction or a reduced permeability to chemicals, and a liquid injection molding method (LIM) for forming the operable surface by chemically bonding the coating layer to the heat curable rubber.

2. Background Art

The properties of curable rubber have recently been further improved by addition of coating layers, e.g., polytetraflurorethyene (PTFE) to curable silicone rubber. In 1998, in U.S. Pat. No. 5,767,185, Reo disclosed forming a silicone and polytetrafluoroethylene (PTFE) windshield wiper blade, wherein the PTFE and silicone blade provided a lower coefficient of friction as compared to the coefficient of friction provided by a blade having just silicone.

Curable rubber alone may also be used in the medical, analytical chemistry, and biotechnological fields, to cover containers that may be used for conducting multiple tests on samples. Often covers that seal the container and are chemically inert to the contents are required so that the chemicals contained therein will not be spilled or otherwise released to the surrounding environment, contiguous containers, contiguous compartments of a container or become contaminated with outside agents. Chemicals, samples or test reagents may be injected through the covers into the containers, or in some instances, directly into the compartments of the vial pack using a micro pipette equipped with a tip or a syringe equipped with a needle. Hereinafter, “chemicals” refers to samples or test reagents used in the medical, analytical chemistry, and biotechnological fields for conducting multiple tests on samples. Hereinafter, “biotechnological” means the use of microorganisms, such as bacteria or yeasts, or biological substances, such as enzymes, to perform specific industrial or manufacturing processes. Applications include, but are not limited to, the production of industrial chemicals, certain drugs, synthetic hormones, and bulk foodstuffs as well as the bioconversion of organic waste and the use of genetically altered bacteria in the cleanup of oil spills.

However, use of curable rubber may be limited to use with chemicals that do not for example react with the rubber. Chemicals that break at least one covalent bond in the curable rubber are said to “react” with the curable rubber. Use of curable rubber may also be limited to use with chemicals that do not permeate into the curable rubber. Chemicals that are absorbed into the curable rubber are said to “permeate” into the curable rubber and cause swelling. “Degradation” is a process that occurs when chemicals “react” or “permeate” into the curable rubber causing it to lose strength and other desirable properties. There is a need to protect the curable rubber from said chemicals because degradation of the curable rubber of the cover may cause leakage or spillage or contamination of the surrounding environment by the “chemicals.” Also, a need exists to form curable rubber compositions comprising, for example, silicone rubber or other organic or inorganic materials that may provide benefits that the curable rubber alone does not provide.

### SUMMARY OF THE INVENTION

The present invention provides a method for forming an apparatus, comprising:

providing a mold having an exposed surface, wherein the exposed surface includes at least one cavity;

providing a coating layer material on the exposed surface;

injecting a curable rubber into the cavity, resulting in forming the apparatus, and wherein a portion of a surface of the apparatus is an operable surface, and wherein the operable surface is the coating layer material chemically bonded to the curable rubber.

A second embodiment of the present invention provides a method for forming a coating layer on a curable silicone rubber layer comprising:

providing a mold having an exposed surface, wherein the exposed surface includes at least one cavity;

providing a coating layer material on the exposed surface;

injecting the curable silicone rubber into the cavity; and

bonding the coating layer chemically to the curable silicone rubber.

A third embodiment of the present invention provides an article comprising:

a coating layer chemically bonded to a curable silicone rubber layer; wherein the coating layer has an effective thickness (Tₑ) defined as: Tₑ≧F*T, wherein F is a thinning fraction and is equal to a surface area (SAₒ) of an opening of a cavity of a mold divided by a surface area (SA_{c}) inside the cavity of said mold, and wherein T is a thickness of the coating layer material.

### BRIEF DESCRIPTION OF THE DRAWINGS

FIG. 1A depicts a front cross-sectional view of an apparatus, wherein an operable surface of the apparatus is a coating layer chemically bonded to a curable rubber layer, according to embodiments of the present invention;

FIG. 1B depicts a front cross-sectional view of a liquid injection molding (LIM) device equipped for forming the operable surface of the apparatus depicted in FIG. 1A;

FIG. 1C depicts the device of FIG. 1B after forming the operable surface of the apparatus depicted in FIG. 1A;

FIG. 1D depicts a front cross-sectional view of a liquid injection molding (LIM) device equipped for forming an operable surface of an apparatus for covering a sample container, according to embodiments of the present invention;

FIG. 2 depicts the device of FIG. 1D after forming the operable surface of the apparatus of FIG. 1D;

FIG. 3 depicts the operable surface of the apparatus of FIG. 2 after removing the apparatus from the LIM device of FIG. 1D;

FIG. 4 depicts a flow chart of a method for forming an operable surface of an apparatus, wherein the operable surface of the apparatus is a coating layer chemically bonded to a curable rubber, according to embodiments of the present invention;

FIG. 5A depicts a top perspective view of an apparatus, according to embodiments of the present invention;

FIG. 5B depicts a front cross-sectional view of the apparatus as taken through 5B-5B of FIG. 5A;

FIG. 6A depicts a top perspective view of an operable surface of an apparatus comprising plug portions, wherein the operable surface of the apparatus is a coating layer chemically bonded to an at least one plug portion, according to embodiments of the present invention;

FIG. 6B depicts a front cross-sectional view of the apparatus as taken through 6B-6B of FIG. 6A;

FIG. 7 depicts a front cross-sectional view of a cutter for removing an at least one plug portion, according to embodiments of the present invention;

FIG. 8 depicts a front cross-sectional view of a liquid injection molding (LIM) device equipped for forming an operable surface of an apparatus for covering a sample container, according to embodiments of the present invention;

FIG. 9 depicts FIG. 8, after removing the apparatus from the LIM device;

FIG. 10 depicts a front cross-sectional view of a LIM device equipped for forming an operable surface of an apparatus for covering a vial, according to embodiments of the present invention;

FIG. 11 depicts FIG. 10, after forming the operable surface of the apparatus;

FIG. 12 depicts FIG. 11, after removing the apparatus and a portion of the LIM device;

FIG. 13 depicts a front cross-sectional view of an operable surface of an apparatus for covering a vial, according to embodiments of the present invention; and

FIG. 14 depicts FIG. 13, after forming a kit comprising the apparatus and a vial.

### DETAILED DESCRIPTION OF THE PREFERRED EMBODIMENTS

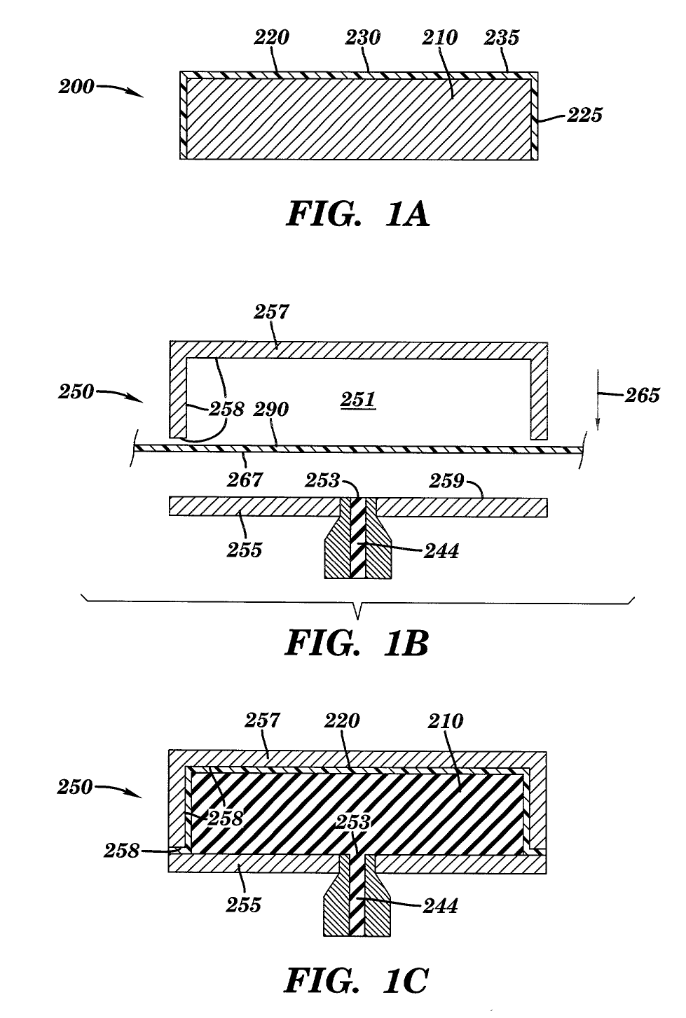

FIG. 1A depicts a front cross-sectional view of an apparatus 200 comprising a top surface 235 of a coating layer 220 and a side surface 225 of the coating layer 220, wherein the coating layer 220 is chemically bonded to an exposed surface of the curable rubber layer 210, and wherein the coating layer 220 forms an operable surface 230 of the apparatus 200. The operable surface 230 of the apparatus 200 may be, for example, a coating layer 220 chemically bonded to, for example, a septum, a plug or a closure for covering a container such as, for example, a vial, when the apparatus is used, for example, to contain chemical samples. Alternatively the coating layer 220 may be formed on the curable rubber layer 210 of the apparatus 200 such as, for example, a sample container cover having a plurality of plug portions for covering a plurality of containers such, as for example, a vial pack or micro pack, when the apparatus is used to contain chemical samples. In addition, the coating layer 220 may be formed on the curable rubber layer 210 of the apparatus 200 such as, for example, an automotive windshield wiper blade or any laminated article having the coating layer 220 on the curable rubber layer 210.

In one embodiment, the apparatus 200 may be a windshield wiper for an automotive windshield and the coating layer 220 may be chemically bonded to the operable surface 230 of the apparatus 200 that contacts the automotive windshield. Alternatively, the apparatus 200 may be a closure for a container and the coating layer 220 may be chemically bonded to the operable surface 230 of the apparatus 200 that contacts the container.

The curable rubber includes products such as LIM® 3745, LIM® 6745-D1, LIM® 8040, SE6740, SE6750, SE6770, Baysilone LSR 2010 TP 3734, Baysilone LSR 2050, TSE221-3U, TSE221-5U or TES221-6U, all of which are heat curable silicones available from the Silicone Division of the General Electric Company. However it should be appreciated that many equivalents may be used. The curable rubber may be any other silicone elastomer, organic elastomer, viton, sanoprene, or EPDM. Hereinafter, EPDM includes butylene/ethylene/alpha-olefin/diene monomers, wherein butylene, ethylene, alpha-olefin and diene are each monomers. The alpha-olefin includes propylene and the diene includes 1,4-hexadiene (HD). The monomer, diene, may be present in an amount of about 1 to 15 percent by weight based on a weight of EDPM. It is preferred that the polymer contain two or three monomers inclusive of ethylene. The butylene/ethylene/alpha-olefin/diene polymer may be selected from any of those known in the art and/or commercially available, including those that are heterogeneously branched, such as those produced using Ziegler-Natta type catalysts, and those that are homogeneously branched. Examples include butylene/ethylene/alpha-olefin/diene polymers available from DuPont Dow Elastomers L.L.C., such as NORDEL® 1040 and NORDEL® 1070 (each a 5 wt % ethylene, 44 wt % propylene, and 3 wt % 1,4-hexadiene (HD) derived EPDM), and those available from Exxon under the name VISTALON™, for instance VISTALON™ 2504 (a 50 wt % ethylene, 45 wt %F propylene and 5 wt % ethylidene norbornene (ENB) derived EPDM). The curable rubber material may be colored blue, or alternatively any of the other primary colors such as red, yellow, green, or any combinations thereof. Alternatively, the curable rubber material may be clear or opaque.

The coating layer material may be polytetrafluoroethylene (PTFE) sheet because, for example, PTFE is known to be chemically resistant to solvents such as toluene, acetone, or other chemicals and PTFE is also known to be impermeable to such solvents and other chemicals. Hereinafter “chemically resistant” refers to the coating layer materials such as PTFE, wherein the coating layer material does not “react” or “degrade” in the presence of a chemical in a sample container. Hereinafter, a coating layer on the curable rubber layer is not permeable to solvents and chemicals if it does not absorb the solvents and chemicals or allow them to penetrate into the curable rubber layer.

Referring to FIG. 1A, the coating layer 220 may be formed on the curable rubber layer 210 of an apparatus such as for example an automotive windshield wiper blade or any laminated article having the coating layer 220 on the curable rubber layer 210 in order to decrease the coefficient of friction of the curable rubber layer 210.

Referring to FIG. 1A, in one embodiment of the present invention, the coating layer material may be made from a continuous sheet of cast liquid polytetrafluoroethylene (PTFE) which is commercially available from E.I. DuPont de Nemours as FEP type 200° C., having a thickness from about 0.1 mils to about 10 mils. The coating layer material may be chemically etched on an at least one surface thereof using sodium or potassium in liquid ammonia, sodium naphthalene, or other etching agents known in the art, which are capable of substituting hydroxyl or other hydrophylic groups for fluorine groups on the etched surface. Alternatively the at least one surface of the coating layer material may be etched using plasma. Hereinafter, “hydrophilic groups” means water miscible groups that include polar organic groups such as hydroxyl that may replace, for example, fluorine groups, when the at least one surface of the coating layer material is chemically or plasma etched. In embodiments of the present invention, a curable rubber, such as, for example, a heat curable silicone, having hydroxyl or other hydrophilic groups, may chemically condense with hydrophilic groups on the etched surface of the coating layer when the curable rubber contacts the etched surface of the coating layer material. Hereinafter, “chemically bonded” and “chemically bonding” mean forming a coating layer on a curable rubber layer, wherein chemical or plasma etching has produced a hydrophilic surface on the at least one surface of the coating layer material and wherein heating the coating layer on the curable rubber layer cures the curable rubber and forms chemical bonds between the hydrophilic surface of the coating layer and the curable rubber layer by, for example, chemical condensation, resulting in directly bonding the coating layer to the curable rubber layer. Alternatively, both faces of the coating layer material may be etched using either chemical or plasma etching. Alternatively, the coating layer material may also be untreated PTFE, wherein chemical bonding may result by condensation of naturally occurring hydrophilic sites on the surface of the coating layer material and the exposed surface of the curable rubber layer.

It should be understood that many equivalents for the coating layer material exist, such as a continuous roll of cast liquid polytetrafluoroethylene, polytetrafluoroethylene, fluorinated ethylene propylene or aluminum foil. The coating layer material may be colored blue, or alternatively, any of the other primary colors such as red, yellow, green, or any combinations thereof. Alternatively, the coating layer material may be clear or opaque.

Referring to FIG. 1A, undesirable degradation of the curable rubber layer 210 may occur when “chemicals” such as samples or test reagents have permeated or penetrated through the coating layer 220. Therefore, referring to FIG. 1B, one skilled in the art should use a sheet of the coating layer material 290 having a thickness (T) such that the coating layer 220 will have an effective thickness (Tₑ) needed to avoid degradation of the curable rubber layer 210 due to penetration or permeation of the coating layer 220 by “chemicals” in the chemical samples. (See Formulas 1 and 2 and associated text, infra, for discussion on determination of T and Tₑ.)

Referring to FIG. 1A, when a purpose of the coating layer 220 is to decrease the coefficient of friction of the curable rubber layer 210 in order that the curable rubber layer 210 and the coating layer 220 may be used as the blade of an automotive windshield wiper, the effective thickness (Tₑ) of the coating layer 220 may be a minimum thickness needed to decrease the coefficient of friction of the curable rubber layer 210. If the thickness of the coating layer 220 is less than the effective thickness (Tₑ), the coating layer 220 may be unable to decrease the coefficient of friction of the curable rubber layer 210.

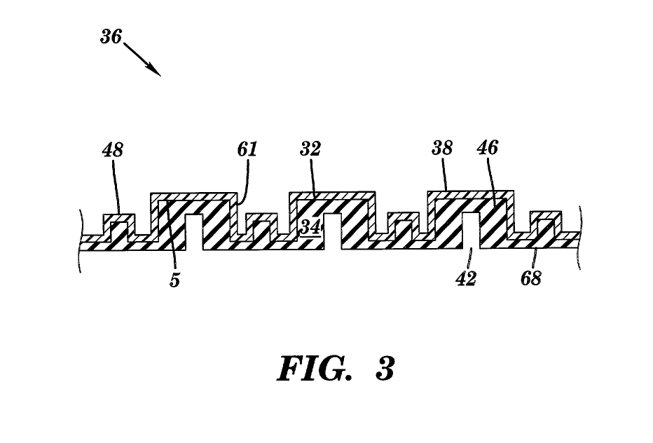

FIG. 4 depicts a flowchart for a liquid injection molding (LIM) method 10 for forming, for example, the apparatus 200 depicted in FIG. 1A and described in associated text supra. Referring to FIG. 4, the method 10 comprises steps 12-17: step 12, providing a mold having an exposed surface, wherein the exposed surface includes at least one cavity; step 14, providing a coating layer material on the exposed surface and cavity; step 16, injecting a curable rubber into the cavity; and step 17, chemically bonding the coating layer to the curable rubber. FIGS. 1B-1C depict a front cross-sectional view of a liquid injection molding (LIM) device for forming an apparatus 200, as depicted in FIG 1A, having the coating layer 220 chemically bonded to the curable rubber layer 210, in accordance with the steps 12-17 of the method 10.

FIG. 1B depicts a LIM device 250 comprising: a heated mold half 257; having a surface 258 and at least one cavity 251 therein, and a heated mold half 255, having a surface 259 and an inlet 244 for injecting a curable rubber through an injector 253. Referring to FIG. 1B, a thin sheet 290 of the coating layer material may be provided on the surface 258 of the mold half 257, such that the sheet 290 of the coating layer material substantially covers the at least one cavity 251 of the mold half 257. It should also be appreciated that the coating layer material can be applied or sprayed directly onto the surface 258 of the mold half 257. This can be in addition to or instead of providing the sheet 290 of the coating layer material on the surface 258 of the mold half 257.

FIG. 1C depicts FIG. 1B after the mold halves 257 and 255 have been heated from about 150° C. to about 180° C. A portion of the surface 258 of the heated mold 257 and a portion of the surface 259 of the heated mold 255 have come together, sandwiching the sheet 290 of the coating layer material between them. The mold halves 257 and 255 may have been moved together by moving the mold half 257 toward the mold half 255 in a direction of an arrow 265 or alternatively, the mold half 255 and the transfer line 244 may be moved in the direction counter to the arrow 265 or any combination thereof.

Referring to FIG. 1B, the injector 253 of the mold half 255 may impinge against the etched surface 267 of the sheet 290, in preparation for injecting the curable rubber into the LIM device 250, in accordance with step 16 of the method 10, as depicted in FIG. 4 and described in associated text supra. Alternatively, use of coating material in which both faces of the sheet 290 may be etched avoids a curling of the sheet 290 that may result when the sheet 290 is placed on the mold half 257 when a temperature of the mold half 257 is equal to or above a softening temperature of the coating layer material.

Referring to FIG. 1C, an effective amount of the curable rubber has been injected into the LIM device 250, using about 100 bar to about 300 bar through feed line 244 and injector 253 of the mold half 255. Referring to FIGS. 1B-1C, injecting under the conditions of pressure described supra resulted in stretching the sheet 290 of the coating layer material and conformally coating the at least one cavity 251 of the mold half 257 with coating layer material. Hereinafter, an effective amount of curable rubber is the amount necessary to fill the at least one cavity 251 of the mold half 257. It should be understood that the effective amount of the curable rubber will vary with the size and dimensions of the cavity 251. In FIG. 1C, filling the at least one cavity 251 of the mold half 257 at a temperature of from about 150° C. to about 180° C. for from about 15 seconds to about 45 seconds resulted in chemically bonding the sheet 290 of the coating layer material to the cured rubber layer 210 and resulted in forming the coating layer 220.

Referring to FIGS. 1B-1C, in an embodiment of the present invention, when sheet 290 of the coating layer material had a thickness of from about 0.1 mils to about 8 mils, the sheet 290 was chemically bonded to the curable rubber layer 210 such that a thickness of the coating layer 220 between the curable rubber layer 210 and the surface 258 of the mold half 257 included from about 0.1 mils to about 5 mils. It should be understood that stretching the sheet 290 of the coating layer material may result in a thinning of the sheet 290. An effective thickness (Tₑ) of the coating layer 220 resulting from stretching the sheet 290 of the coating layer material includes the effective thickness (Tₑ) determined using Formula 1 infra. Formula 1 infra is used to determine the effective thickness (Tₑ) by multiplying a thickness (T) of the sheet 290 of the coating layer material times a thinning fraction (F). The thinning fraction (F) may be determined using Formula 2 infra by dividing a surface area (SAₒ) of an opening of the at least one cavity 251 by a surface area (SA_{c}) inside the cavity 251.

T×F≧Tₑ 1.

F=SAₒ/SA_{c} 2.

According to Formula 1, a value of (Tₑ) may not be less than an effective thickness needed to accomplish a purpose of the coating layer 220. Hereinafter, when the purpose of the coating layer 220 is to prevent permeation or penetration of “chemicals” into the curable rubber layer 210, (Tₑ) is a minimum thickness of the coating layer 220 needed to prevent permeation or penetration of “chemicals” such as samples or test reagents through the coating layer 220 that cause undesirable degradation of the curable rubber layer 210. If the thickness of the coating layer 220 is less than the effective thickness (Tₑ), the coating layer 220 will be unable to prevent undesirable degradation of the curable rubber layer 210 due to permeation or penetration of “chemicals” such as samples or test reagents through the coating layer 220.

FIG. 1D depicts a LIM device 25, comprising: a mold half 31; having a surface 15 and a plurality of cavities 37 therein, and a mold half 35, having a surface 39 and an inlet 44 for injecting a curable rubber through an injector 33, in accordance with the step 12 of the method 10, as depicted in FIG. 4 and described in associated text supra. Referring to FIG. 1D, the device 25 further comprises spools 27 and 28, that may provide, in accordance with step 14 of the method 10, a thin sheet 29 of a coating layer material on the surface 15 of the mold half 31, such that the sheet 29 of the coating layer material substantially covers an at least one cavity 37 of the mold half 31. The thin sheet 29 of the coating layer material is provided on the surface 15 of the mold half 31 in a direction of an arrow 26 when the spools 27 and 28 are rotated in a clockwise direction on an axis orthogonal to the plane of FIG. 1. It should also be appreciated that the coating layer material can be applied or sprayed directly onto the surface 15 of the mold half 31. This can be in addition to or instead of feeding the sheet 29 of the coating layer material onto the surface 15 of the mold half 31 from the roller 27.

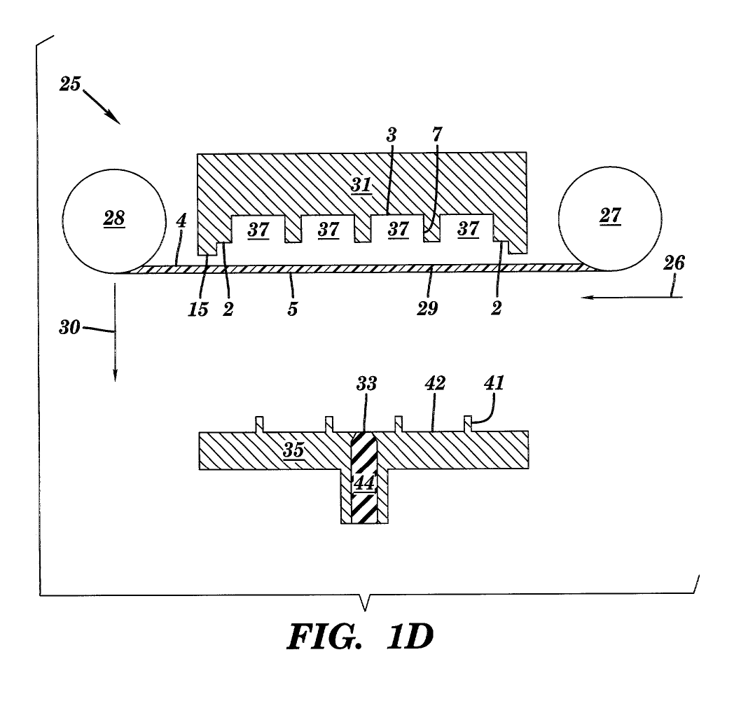

FIG. 2 depicts FIG. 1D after the mold halves 31 and 35 have been heated from about 150 ° C. to about 180° C. The surface 15 of the heated mold half 31 and the surface 39 of the heated mold half 35 have come together, sandwiching the sheet 29 of the coating layer material between them. The mold halves 31 and 35 may have been moved together by moving the mold half 31, and the spools 27 and 28, toward the mold half 35 in a direction of an arrow 30 or alternatively, the mold half 35 and the transfer line 44 may be moved in the direction counter to the arrow 30 or any combination thereof.

Referring to FIG. 2, the injector 33 and optionally at least one needle guide forming portion 41 of the mold half 35 may impinge against the etched surface 5 of the sheet 29. An effective amount of curable rubber has been injected into the LIM device 25 in accordance with the step 16 of the method 10, using about 100 bar to about 300 bar through feed line 44 and the injector 33 of the mold half 35. The curable rubber 34 contacting the etched surface 5 of the sheet 29 cured in about 15 to about 45 seconds when the mold halves 31 and 35 were maintained at a temperature from about 150° C. to about 180° C. Contacting the etched surface 5 of the sheet 29 with the curable rubber 34 resulted in chemically bonding the curable rubber material with the coating material, forming the coating layer 32. Alternatively, it has been found that contacting untreated coating material with the curable rubber 34 also resulted in chemically bonding the curable rubber material with the coating material, forming the coating layer 32. However, it has been found that contacting the etched surface 5 of the sheet 29 with the curable rubber 34 resulted in fewer wrinkles and imperfections in the coating layer 32. Hereinafter, imperfections are portions of the coating layer 32, wherein a color of the curable rubber layer 34 becomes visible using visual inspection because a thickness of the coating layer 32 has become sufficiently thin so as to allow the color of the curable rubber 34 to be visible using visual inspection. Hereinafter, a wrinkle is a small furrow, ridge, or crease on a smooth surface of the coating layer 32, caused by crumpling, folding, or shrinking of the coating layer 32. Alternatively, both faces of the coating layer material may be etched. Referring to FIG. 1D, use of the sheet 29 having both surfaces of the sheet 29 etched allows contacting the etched surface 5 of the sheet 29 with the curable rubber 34 and contacting the other etched surface of the sheet 29 with the surface 15 of the mold half 35. Contacting the other etched surface 3 of the sheet 29 with the surface 15 of the mold half 31 avoids a curling of the sheet 29 of the coating layer material that may result when the sheet 29 is placed on the mold half 31 when a temperature of the mold half 31 is equal to or above a softening temperature of the coating layer material.

Referring to FIG. 2, injecting under the conditions of pressure and temperature described supra resulted in stretching the sheet 29 of the coating layer material and conformally coating a wall 7, an end 3 of the cavity 37 and a recessed cavity 2 of the mold half 31 with coating layer material. Hereinafter, the effective amount of curable rubber is the amount necessary to fill the at least one cavity 37 and the recessed cavities 2 of the mold half 31. It should be understood that the effective amount of the curable rubber will vary with the size and dimensions of the cavity 37. In FIG. 2, filling the cavities 37 of the mold half 31 in the presence of heat resulted in bonding the sheet 29 of the coating material to the curable rubber layer 34, forming the coating layer 32.

Referring to FIG. 2, injecting under the conditions of pressure and temperature described supra resulted in forming the coating layer 32. In an embodiment of the present invention, when a thickness of the sheet 29 of the coating layer material included from about 0.1 mils to about 8 mils, the sheet 29 of the coating layer material was chemically bonded to the curable rubber layer 34 such that a thickness of the coating layer 32 between the curable rubber layer 34 and the end 3 of the cavities 37, between the curable rubber layer 34 and the wall 7 of the cavities 37 and between the curable rubber layer 34 in the recessed cavities 2 and an outer wall of the mold half 31 included from about 0.1 mils to about 5 mils. It should be understood that stretching the sheet 29 of the coating layer material may result in a thinning of the sheet 29 of the coating layer material. An effective thickness (Tₑ) of the coating layer 32 resulting from stretching the sheet 29 of the coating layer material includes the effective thickness (Tₑ) determined using Formula 1 supra. Formula 1 supra is used to determine the effective thickness (Tₑ) by multiplying a thickness (T) of the sheet 29 of the coating layer material times a thinning fraction (F). The thinning fraction (F) may be determined using Formula 2 supra by dividing a surface area (SAₒ) of a portion of the sheet 29 over an opening of each cavity 37 by a surface area (SA_{c}) inside the cavities 37.

Referring to Formula 1 supra the value of (Tₑ) may not be less than a thickness needed to accomplish a purpose of the coating layer 32. Hereinafter, when the purpose of the coating layer 32 is to prevent permeation or penetration of “chemicals” into the curable rubber layer 34, the effective thickness (Tₑ) of the coating layer 32 includes a minimum thickness needed to prevent permeation or penetration of “chemicals” such as samples or test reagents through the coating layer 32 that cause undesirable degradation of the curable rubber 34. If the thickness of the coating layer 32 is less than the effective thickness (Tₑ). the coating layer 32 will be unable to prevent undesirable degradation of the curable rubber layer 34 due to permeation or penetration of “chemicals” such as samples or test reagents through the coating layer 32.

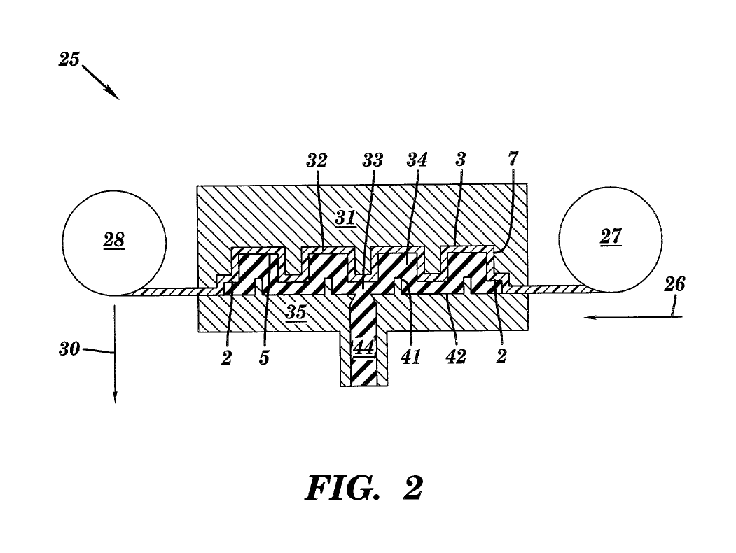

FIG. 3 depicts FIG. 2 after separating the mold half 31 and the mold half 35 and removing the apparatus 36 of FIG. 3 from the mold halves, 31 and 35. The apparatus 36 of FIG. 3 has been formed by chemically bonding the sheet 29 of the coating layer material to the curable rubber layer 34 forming the coating layer 32. Referring to FIG. 3, the apparatus 36 may be, for example, a sample container cover 36 generally including a support sheet 68, a plurality of plug portions 46 and the effective thickness (Tₑ) of the coating layer 32 covering the plug portions 46 and the support sheet 68, wherein a surface 38 of the coating layer 32 may be an operable surface 38 of the apparatus 36. The plug portions 46 further comprise the curable rubber portion 34, a side 61 of the plug portion 46, an optional needle aperture 42, and optional ribbing 48. The needle aperture is optional and further reduces a weight of the apparatus 36. The ribbing 48 is optional and can be used to join the plug portions 46 together and extend around a periphery of the sample container cover 36 in order to increase the overall durability and strength of the sample container cover 36.

Referring to FIG. 4, when one skilled in the art follows the steps 12-17 of the method 10 and applies the Formulas 1 and 2, described supra, the coating layer material 32 as depicted in FIG. 3 and described in associated text supra resulted in stretching the sheet 29 of the coating layer material and conformally coating the at least one cavity 37 of the mold half 31 with coating layer material, forming the coating layer 32. Referring to FIG. 2, in an embodiment of the present invention, when sheet 29 of the coating layer material had a thickness from about 0.1 mils to about 8 mils, the sheet 32 was chemically bonded to the curable rubber layer 34 such that the thickness of the coating layer 32 between the curable rubber layer 34 and the surface 3 of the mold half 31 included from about 0.1 mils to about 5 mils.

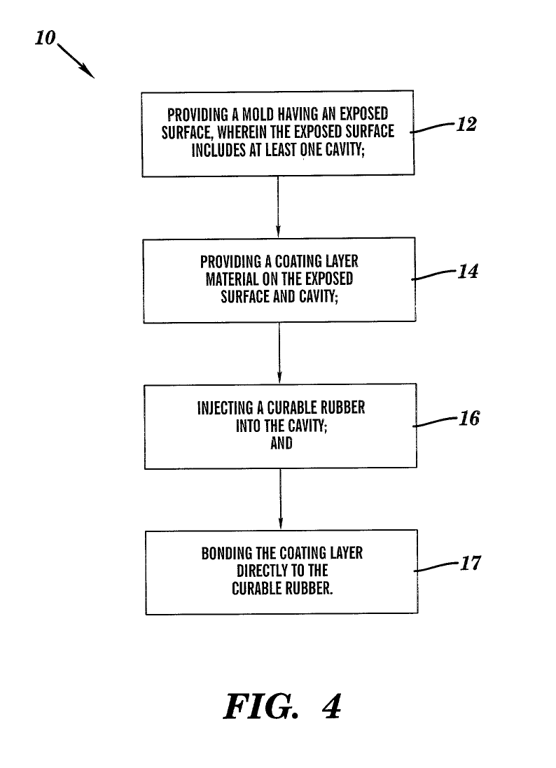

FIG. 5A depicts an apparatus 80, having a plurality of compartments 83, a top surface 87 and a body 89 wherein the compartments 83 are arranged in “m” rows and “n” columns. Alternatively the arrangement of the compartments in the apparatus 80 may be expressed as an “m” by “n” “arrangement” or “array”, wherein “m” and “n” may be any real numbers. The compartments 83 are open at one end 85 for introducing chemical samples or placing vials into the apparatus 80. The apparatus 80 may be molded plastic, wherein the surface 87 may be formed by coating the molded plastic with a vinyl plastic or other material resistant to “permeation” or “degradation” by chemicals of the present invention. Alternatively, the apparatus 80 may be metal, wherein the surface 87 may be formed by coating the metal with a vinyl plastic or other material resistant to “permeation” or “degradation” by chemicals of the present invention.

FIG. 5B depicts a front cross-sectional view of the apparatus 80 further comprising a wall 88 of the compartment 83 of the apparatus 80.

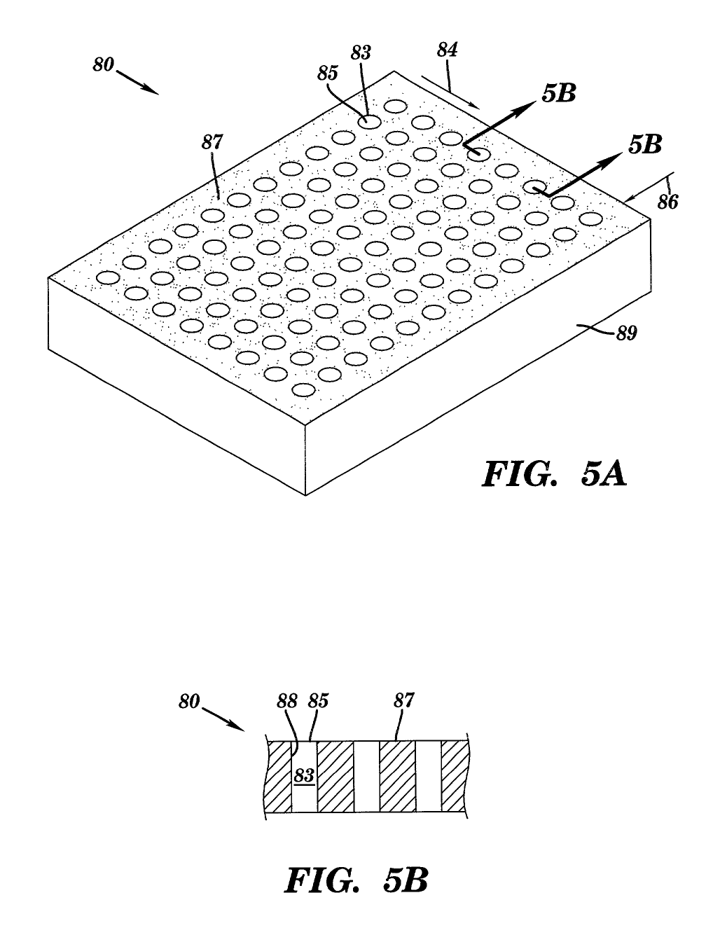

FIG. 6A depicts a top view of an apparatus 70 comprising: an at least one plug portion 72, wherein the at least one plug portion 72 may be arranged in “m” rows by “n” columns, wherein “m” and “n” may be any real numbers. The apparatus 70 further comprises: a top surface 73 of the at least one plug portion 72; a side surface 75 of the at least one plug portion 72; and a side surface 78 of a support sheet of the apparatus 70. Referring to FIG. 6A, the apparatus 70 may be a container cover 70, having the “m” by “n” arrangement of plug portions 72. A volume of each plug portion 72 may include from about 0.01 cc to about 3.5 cc, wherein the cavities 37 may be separated in an x-y plane by a distance from about 0.05 cm. to about 0.5 cm. Since the opening 85 of the compartments 83 of the container 80 may be closed by inserting the at least one plug portion 72 of the container cover 70 into the openings 85 of the compartments 83, the at least one plug portion 72 must be formed on the apparatus 70 such that the plug portions may align with the openings 85 of the compartments 83 of the container 80.

FIG. 6B depicts a front cross-sectional view of the apparatus 70, further comprising: a coating layer 81 chemically bonded to a curable rubber layer 96; and an operable surface 77 of the apparatus 70 further comprising: a top surface 73 of the at least one plug portion 72; a side surface 75 of the at least one plug portion 72; and the surface 77 of the support sheet 79 of the apparatus 70. Referring to FIGS. 6A-6B, the apparatus 70 may be formed in accordance with the steps 12-17 of the method 10, depicted in FIG. 4 and described in associated text supra, from the mold half 31 that includes cavities 37, depicted in FIGS. 1D-2 and described in associated text supra. Referring to FIG. 6B, the apparatus 70 further comprises an optional needle aperture 71.

Referring to FIG. 5A, the apparatus 80 may be a container having a plurality of compartments 83, comprising openings 85, sides 88, and a top surface 87. Referring to FIG. 4, when one skilled in the art follows the steps 12-17 of the method 10 and applies the Formulas 1 and 2, described supra, the coating layer material as depicted in FIG. 6B and described in associated text supra may have an effective thickness (Tₑ) from about 0.1 to about 5 mils and may be chemically bonded to the curable rubber portion 96 of the apparatus 70.

Referring to FIG. 6B, the surface 77 of the coating layer 81 may form an operable surface 77 of the apparatus 70. For example, referring to FIG. 6B, the apparatus 70 may be a container cover 70 that was formed and removed from the LIM device 90. Referring to FIG. 6B, an example of a purpose of the coating layer 81 is to ensure that the container cover 70, and more specifically the at least one plug portion 72, do not become degraded or damaged by the materials placed within the compartments 83 or the vials in the compartments 83, as depicted in FIG. 5A and described in associated text supra. In addition, the coating layer 81 may, for example, reduce or prevent a permeation of gasses from inside of the compartments 83 or vials in the compartments 83 into the at least one plug portion 72. The surface 77 of the apparatus 70 may be an operable surface of the apparatus 70, since only the surface 77 of the apparatus 70 contacts the sides 88 and the surface 87 of the container 80, as depicted in FIGS. 5A and 5B. Referring to FIGS. 6A and 6B, in related devices that lack the coating layer 81, not only may increased instances of cover degradation be observed but also increased permeation of gasses through the cover 70 may be observed. Gas permeation through the container cover 70 may lead for example to contamination of the surrounding environment as well as a degraded accuracy of the medical, chemical, or biotechnological test(s) being performed due to loss of the sample.

Referring to FIGS. 5A and 5B, the opening 85 of the compartments 83 of the container 80 may have any three dimensional shape such as cylindrical or cubic and any volume represented by a variable “v”, where “v” may be any real number in cubic centimeters (cc). It should be understood that the volume of the cavities 37 of the mold half 31, depicted in FIGS. 1D-2 and associated text described supra should be substantially similar to “v” to enable the at least one plug portion 72 to seal the openings 85 of the compartments 83 of the container 80. Further, referring to FIGS. 1D, 5A, and 6A, since a separation between centers of adjacent openings 85 of the compartments 83 of the container 80 in a direction of arrow 84, may be any real number represented by a variable “x” in cm, or in a direction of arrow 86 may be any real number represented by a variable “y” in cm, it should be understood that the corresponding separations between centers of the cavities 37 of the mold half 31 in the direction of arrows 74 and 76 should be substantially similar to “x” and “y” in order that the at least one plug portion 72 may align with the openings 85 of the compartments 83 of the container 80.

Referring to FIG. 6A, the at least one plug portion 72 of the container cover 70 may have any three dimensional geometric shape such as a cube or a sphere. Further, the side 75 of the at least one plug portion 72 may assume a beveled shape, wherein the sides 75 of the at least one plug portion 72 may be tapered resulting in a more narrow diameter at the top surface 73 of the at least one plug portion 72 than at a base of the at least one plug portion 72. Alternatively, the beveled shape may result in a wider top portion 73 than the base of the at least one plug portion 72. In addition, referring to FIGS. 5B and 6A, a side surface 75 of the at least one plug portion 72 may be roughened where the side surface 75 contacts the wall 88 of the container compartment 83 of the container 80 to inhibit inadvertent removal of the at least one plug portion 72 from the container compartment 83. The at least one plug portion 72 may have a solid center or the at least one plug portion 72 may be formed, wherein the needle guide 71 extends into the center of the at least one plug portion 72, as depicted in FIG. 6B and described in associated text supra.

Referring to FIGS. 6A and 6B, the coating layer 81 may be formed on the side 78 of the support sheet 79 as was the coating layer 220 formed on the side 225 shown in FIG. 1A and described in associated text supra. Alternatively, referring to FIG. 2, the recessed cavity 2 of the mold half 31 may be absent such that the wall 7 is extended to the surface 42 of the mold half 31, resulting in the cover 70 depicted in FIGS. 6A and 6B and described in associated text supra, wherein the coating layer 81 is not formed on the side 78 of the cover 70.

Referring to FIG. 6A, one skilled in the art may have formed the at least one plug portion 72 in accordance with the method 10, such that a diameter of the plug portion may be greater than a diameter of the opening 85 of the compartments 83, yet still allow the at least one plug portion 72 to be inserted into the opening 85 of the compartments 83 of the container 80 because of a compressibility of the at least one plug portion 72, such that once the at least one plug portion 72 has been inserted into the opening 85 of the compartment 83 of the container 80 they may be resistant to being removed. Referring to FIGS. 5B and 6A, the resistance to being removed may result from an expansion by the side surface 75 of the compressed at least one plug portion 72 against the wall 88 of the compartment 83 of the container 80.

Referring to FIG. 6A, when the at least one plug portion 72 has been formed as described supra to fit the opening 85 in the compartments 83 of the container 80 such that once the at least one plug portion 72 has been inserted into the openings 85 of the compartments 83 of the container 80, the at least one plug portion 72 may be resistant to being removed. Insertion of the at least one plug portion 72 into the container cover 70 may seal the opening in the compartments 83, such that a chemical, biotechnological or medicinal sample inside the compartments 83 may escape into a surrounding atmosphere only by permeation of gasses from the sample through the at least one plug portion 72 instead of by leakage between the side surface 75 of the at least one plug portion 72 and the wall 88 of the compartments 83 of the container 80.

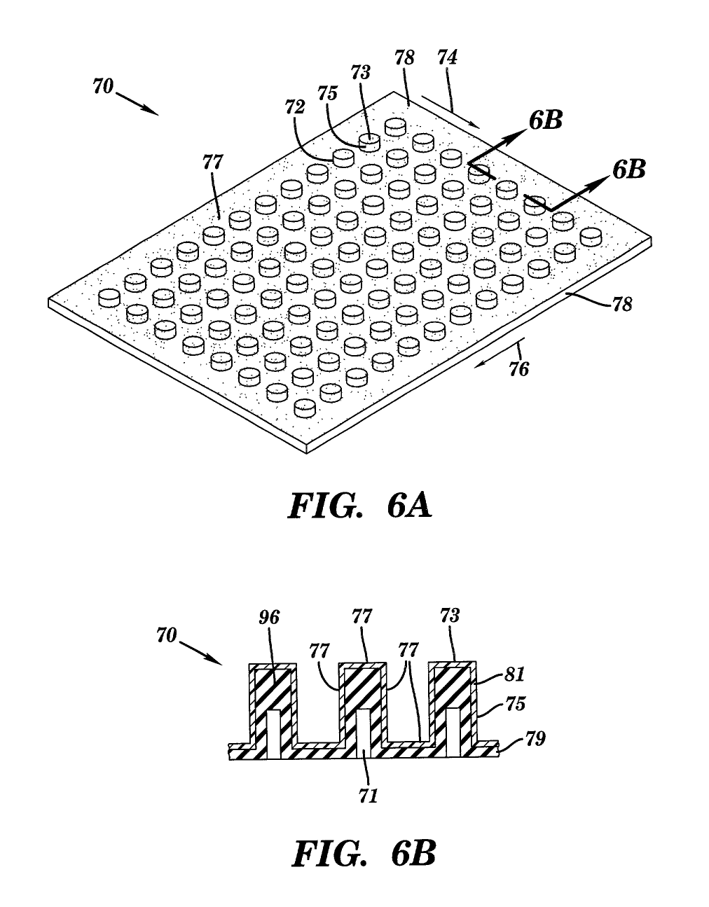

FIG. 7 depicts a front cross sectional view of a cutter 140 comprising a handle portion 142, a cutting portion 144, and a cutting edge 146. FIG. 7 depicts as an example a portion 152 of a cover 154 that comprises a plug portion 148 having a coating layer 156 that may have been formed from coating layer material according to the method 10 as depicted in FIG. 4 and described in associated text supra.

As shown in FIG. 7, the cutter 140 can be used to remove one or more plug portions 148 from the container cover 154. Referring to FIG. 5A, this need arises when a user desires to access the one or more compartments 83 of the container 80, before or after the at least one plug portion 72 of the container cover 70 as depicted in FIG. 6A supra has been inserted into the compartments 83 of the container 80 as depicted in FIG. 5 supra. Referring to FIG. 7, if a variable “J” represents the one or more plug portions 148 removed by the cutter 140 from the container cover 154, and a variable “K” represents a total number of plug portions in the cover 154, then “K-J” equals the one or more compartments 83 of the container 80 that the user can access by removing the “J” number of plug portions 148 from the container cover 154 using the cutter 140. Referring to FIG. 7, without a cutter 140 to remove the “J” number of plug portions 148 from the container cover 154, a user would have to remove “K” number of plug portions 148 from the cover 154 in order to access “x” compartments 83 of the container 80 as depicted in FIG. 5A and described in associated text supra. The ability to remove the “J” number of plug portions 148 from the cover 154 where the “K-J” number of plug portions 148 remain inserted into the compartments 83 of the container 80 gives a user an ability to transfer chemicals into or out of the “J” number of compartments 83 of the container 80 and avoid spillage or contamination of the samples contained therein. Alternatively, the cutter 140 may be used to remove a portion of the apparatus 200, wherein the removed portion may comprise a coating layer chemically bonded to a curable rubber layer, as depicted in FIG. 1A and described in associated text supra. Alternatively, the cutter 140 may be used to remove a portion of the apparatus 36, as depicted in FIG. 3 and described in associated text supra, wherein the removed portion may comprise a plug portion 46 having a coating layer chemically bonded to a curable rubber layer. Alternatively, the cutter 140 may be used to remove a portion of the apparatus 70, as depicted in FIG. 6A and described in associated text supra, wherein the removed portion may comprise a plug portion 72, having a coating layer chemically bonded to a curable rubber layer.

Referring to FIG. 7, the cutter 140 is centered over each of the “J” number of the plug portions 148 inserted into the compartments 83 of the container 80 as depicted in FIG. 5A and described in associated text supra in which access is desired. In FIG. 7, the cutter 140 is then moved in the direction indicated by directional arrow 150 while being rotated about each of the “J” number of plug portions 148. The cutting edge 146 will cut through a support sheet 152, thereby freeing each of the “J” number of plug portions 148 from the container cover 154. Referring to FIG. 5 supra the user may then be left with the “K-J” number of compartments 83 of the container 80 that may be plugged by a plug portion 72 and “J” number of compartments 83 of the container cover 80 that may have been severed by the cutter 140 from the container cover 70 as depicted in FIG. 6A. However, the container cover 70 as depicted in FIG. 6A remains firmly securable over the “K-J” number of compartments 83 in the container 80 as depicted in FIG. 5. Referring to FIG. 7, although a specific design for the cutter 140 has been described, it should be appreciated that many equivalent devices could be used to separate the “J” number of plug portion 148 from the container cover 154 to allow access to the “J” number of compartments 83 of the container 80 as depicted in FIG. 6A. Alternatively, referring to FIG. 7, a portion of the support sheet 152 that includes the “J” number of plug portions 148 of the container cover 154 could be circumscribed with perforations or serrated edges for each of the “J” number of plug portions 148. Hereinafter serations or perforations are cuts into a portion of the support sheet 152 using the cutter 140. When the portion of the support sheet 152 includes circumscribed perforations or serrated edges for each of the “J” number of plug portions 148 of the container cover 154, the user may manually remove the “J” number of plug portions 148 from the “K-J” number of plug portions 148 that remain inserted into the compartments 83 of the container 80.

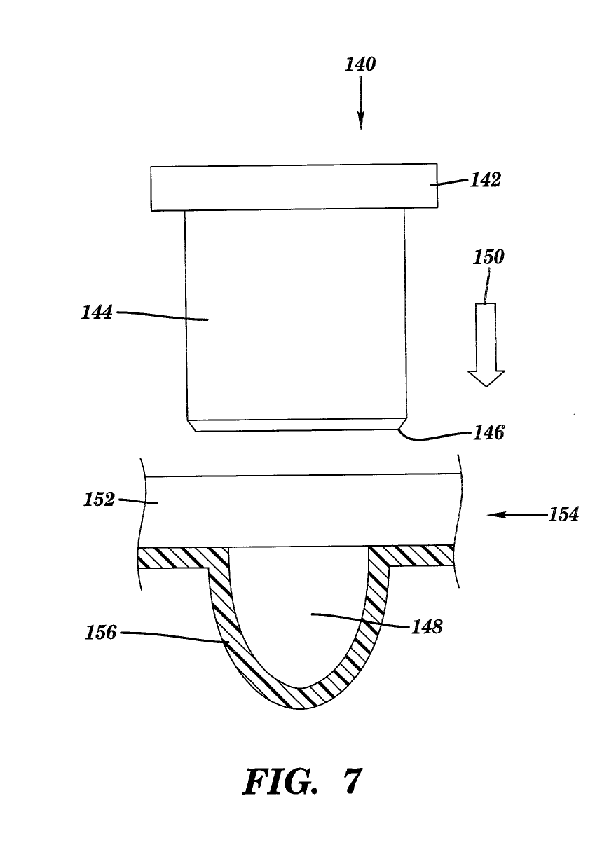

FIG. 8 depicts a front cross-sectional view of a LIM device 90 comprising: a mold half 101 having a plurality of cavities 94 and end cavities 104; a mold half 82 having an inlet 84 and an injector 93, in accordance with the step 12 of the method 10, as depicted in FIG. 4 and described in associated text supra. The mold halves 101 and 82 have been heated to a temperature from about 150° C. to about 180° C. A sheet 111 of the coating layer material, which substantially covered the plurality of cavities 94 and end cavities 104 of the mold half 101 further comprises an etched surface 102 of coating layer material facing the injector 93 in accordance with the step 14 of the method 10.

Referring to FIG. 8, the device 90 further comprises spools 97 and 98, that may have provided, in accordance with step 14 of the method 10, a thin sheet 111 of a coating layer material on a surface 85 of the mold half 101, such that the sheet 111 of the coating layer material substantially covered the plurality of cavities 94 and the end cavities 104 of the mold half 101. The thin sheet 111 of the coating layer material may have been provided on the surface 85 of the mold half 101 in a direction of an arrow 86 when the spools 97 and 98 are rotated in a clockwise direction on an axis orthogonal to the plane of FIG. 8. It should also be appreciated that the coating layer material could have been applied or sprayed directly onto the surface 85 of the mold half 101. This can be in addition to or instead of feeding the sheet 111 of the coating layer material into the apparatus 90 from roller 97.

Referring to FIG. 8, opposing surfaces of the mold halves 101 and 82 have come together, sandwiching the sheet 111 of the coating layer material between them. The mold halves 101 and 82 may have been moved together by moving the mold half 101, and the spools 97 and 98, toward the mold half 82 in a direction of an arrow 88 or alternatively, the mold half 82 and the transfer line 84 may be moved in the direction counter to the arrow 88 or any combination thereof. Referring to FIG. 8, the injector 93 of the mold half 82 and an optional at least one needle guide forming portion 107 may have impinged against the etched surface 102 of the coating layer material. An effective amount of curable rubber has been injected into the LIM device 90, using about 100 bar to about 300 bar through the inlet 84 and the injector 93 of the mold half 82, in accordance with the step 16 of the method 10. Referring to FIG. 8, injecting under the conditions of pressure described supra resulted in stretching the coating layer material and conformally coating a wall 95, an end 91 of the cavities 94 and the end cavities 104 of the mold half 101 with coating layer material. Hereinafter, the effective amount of curable rubber is the amount necessary to fill the cavities 94 and the end cavities 104 of the mold half 101. It should be understood that the effective amount of the curable rubber will vary with the size and dimensions of the cavities 94 and the end cavities 104. Referring to FIG. 8, filling the cavities 94 and the end cavities 104 of the mold half 101 at a temperature from about 150° C. to about 180° C. for from about 15 to about 45 seconds resulted in chemically bonding the sheet 111 of the coating layer material to the curable rubber layer 100, forming the coating layer 92, in accordance with the step 17 of the method 10, as depicted in FIG. 4, and described in associated text supra. In an embodiment of the present invention, when a thickness of the sheet 111 of the coating layer material included from about 0.1 mils to about 8 mils, a thickness of the coating layer 92 between the curable rubber layer 100 and the wall 91 of the mold half 101 included from about 0.1 mils to about 5 mils.

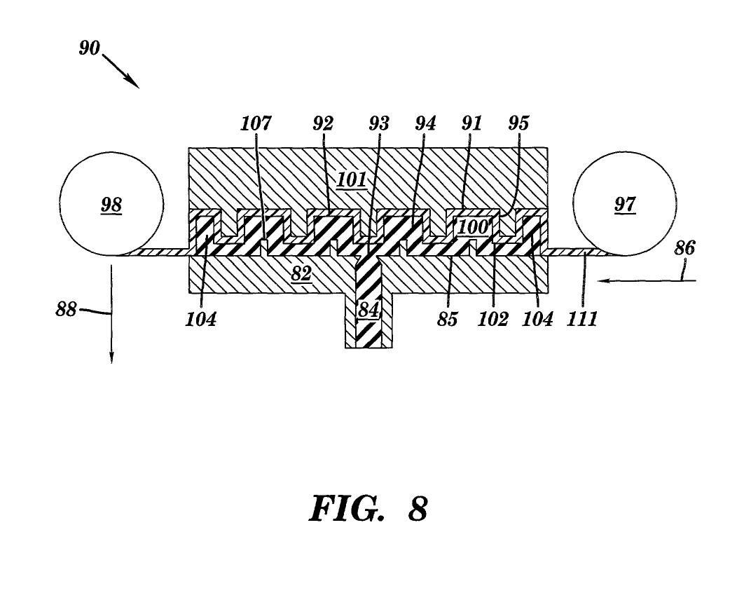

FIG. 9 depicts a front cross sectional view of an apparatus 110, comprising a plurality of covers 105. Referring to FIG. 8, the covers 105 have been formed by chemically bonding the sheet 111 of the coating layer material to the curable rubber layer 94, forming the coating layer 92 that may provide an operable surface 113 of the apparatus 110. Referring to FIG. 9, the apparatus 110 may be, for example, a container cover 110 that was formed using the steps of method 10 as depicted in FIG. 4 supra and removed from the LIM device 90. Referring to FIG. 8, filling the end cavities 104 in the LIM device 90 with curable rubber, may have formed inter alia an at least one container perimeter fastener 108 on a support sheet 112 as depicted in FIG. 9, that may wrap around a surface 87 and a side 89 of the container 80 as depicted in FIG. 5A and described in associated text supra. The at least one fastener 108 as depicted in FIG. 9 may be provided if a tighter seal may be required than may be provided by the frictional resistance provided by for example insertion of the covers 105 of the apparatus 110 into the openings 85 of the compartments 83 of the container 80 as depicted in FIG. 5A and described in associated text supra.

Referring to FIG. 9, the apparatus 110 having a coating layer 92 chemically bonded to the curable rubber layer 94 may be used as a container cover, wherein a surface 113 of the coating layer 92 may be an operable surface 113 of the apparatus 110. The surface 113 may be an operable surface 113 of the apparatus 110 because the at least one container perimeter fastener 108 on the support sheet 112 depicted in FIG. 9 may wrap around the operable surface of the container 80, as depicted in FIGS. 5A and 5B, comprising: the surface 87, the side 89, and the inside wall 88 of the container 80. The apparatus 110 may further comprise a plurality of needle guides 109.

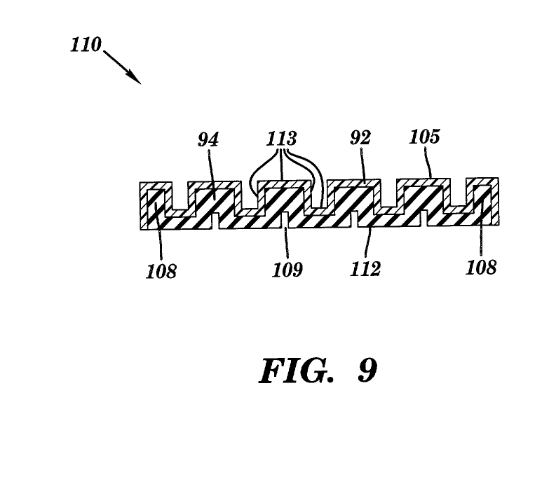

FIG. 10 depicts a front cross sectional view of a LIM device 65 comprising: a heated mold half 51; having a surface 52 and a plurality of cavities 47 therein, and a heated mold half 55, having a surface 59 and an inlet 67 for injecting a curable rubber through an at least one injector 53 according to the method 10, depicted in FIG. 4 and described in associated text supra. The apparatus 65 further comprises a portion 49 of coating layer material having an untreated surface 170 on the surface 8 of the at least one cavity 47 of the mold half 51 and an etched surface 60 facing the at least one injector 53 of the mold half 51, according to the step 12 of the method 10. The portion 49 of the coating layer material may be pre-cut from a sheet of coating layer material. Alternatively, the portion 49 of the coating layer material may be formed by providing a sheet of coating layer material on the mold half 55, with an etched surface of the sheet facing the injector 53 of the mold half 55 and an untreated surface of the sheet facing the surface 8 of the cavities 47, wherein the portion 49 of the coating layer material may be cut out of the sheet by stamping or any appropriate means known by those skilled in the art.

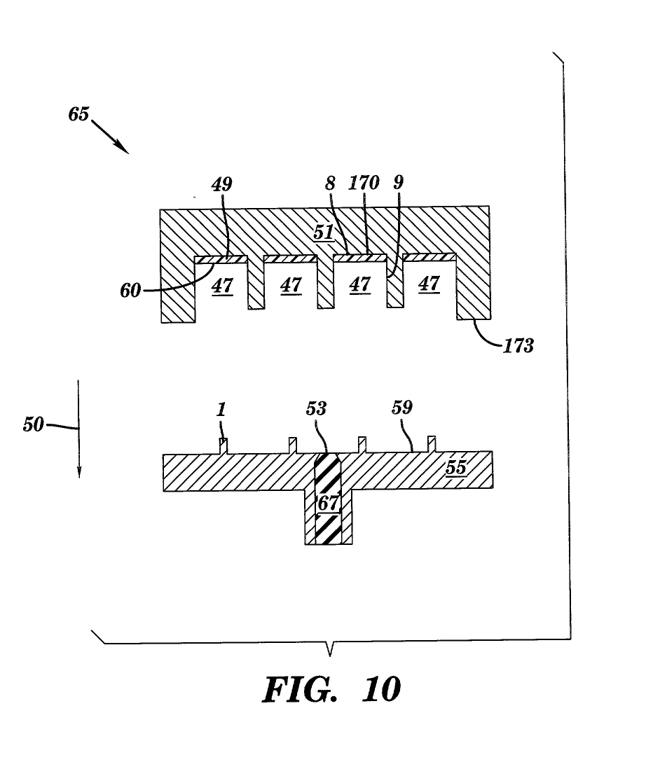

FIG. 11 depicts FIG. 10 after the mold half 51 may have been moved in a direction of an arrow 50 toward the mold half 55, resulting in surfaces 52 of the mold half 51 and 59 of the mold half 55 forming a coplanar surface 175 and in inserting optional needle guide forming portions 1 into the at least one cavity 47 of the mold half 51. The etched surface 60 of the portion 49 of the coating layer material may be etched as described previously. The mold halves 51 and 55 were heated to a temperature from about 150° C. to about 180° C. in preparation for starting the method 10, as depicted in FIG. 4 and described in associated text supra. An effective amount of curable rubber has been injected into the LIM device 65, using about 100 bar to about 300 bar through feed line 67 and injector 53 of the mold half 55, in accordance with the step 16 of the method 10. Referring to FIGS. 10 and 11, the portion 49 of the coating layer material has been chemically bonded to the curable rubber layer 54, forming the coating layer 52, by heating the portion 49 of the coating layer material and the curable rubber layer from about 150° C. to about 180° C. for from about 15 seconds to about 45 seconds, in accordance with the step 17 of the method 10.

Hereinafter, the effective amount of curable rubber is the amount necessary to fill each cavity 47 of the mold half 51. It should be understood that the effective amount of the curable rubber will vary with the size and dimensions of the cavity 47. The curable rubber of method 10 can be any silicone elastomer, organic elastomer, viton, sanoprene, or EPDM.

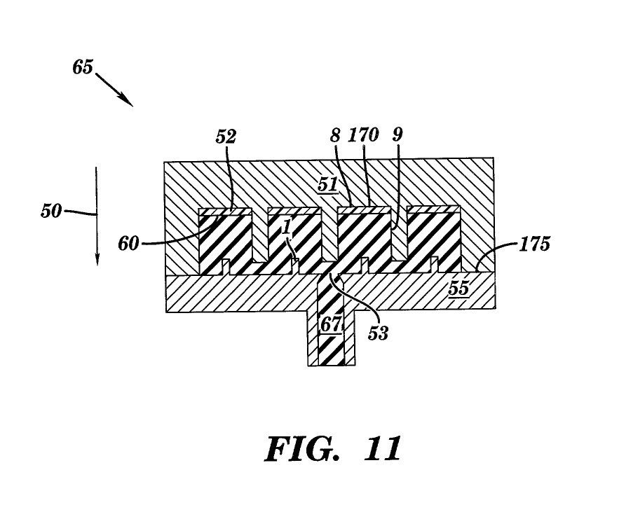

FIG. 12 depicts FIG. 11 after, for example, a workpiece 120 comprising at least one vial cover or septum for covering a vial was formed using the steps of method 10 and removed from the mold halves 51 and 55 of the LIM apparatus 65. The workpiece 120 comprises a plurality of vial covers or septa 63 for covering a vial, wherein the vial covers or septa 63 include a chemically bonded coating layer 52 on a curable rubber layer 54, wherein a surface 170 of the coating layer 52 may be an operable surface of the vial covers or septa 63. The vial covers or septa 63 further comprise a needle guide 126. The vial covers or septa 63 may be separated from a support sheet 128 using the cutter 140 as depicted in FIG. 7 and described in associated text supra. Alternatively, the cutter 140, or any equivalent device having a cutting edge, may be used to create perforations or serrated edges around the perimeter of each of the at least one vial cover or septa 63. The at least one vial cover or septa 63 may be separated from the support sheet 128 by manually putting pressure on each of the at least one vial cover or septa 63 after circumscribing the support sheet 128 where the at least one vial cover or septa 63 are joined to the support sheet 128.

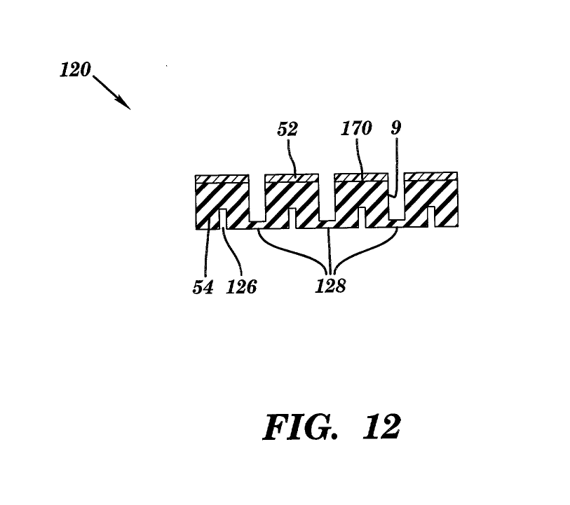

FIG. 13 depicts FIG. 12 after the coating layer 52 has been chemically bonded to the curable rubber layer 52 and for example the apparatus 63 has been separated from the support sheet 128. Referring to FIG. 13, the apparatus 63 may be, for example, a vial cover or septum 63 comprising a curable rubber layer 54, having a side surface 177 and a bottom surface 175, a coating layer 52 and the needle guide 126.

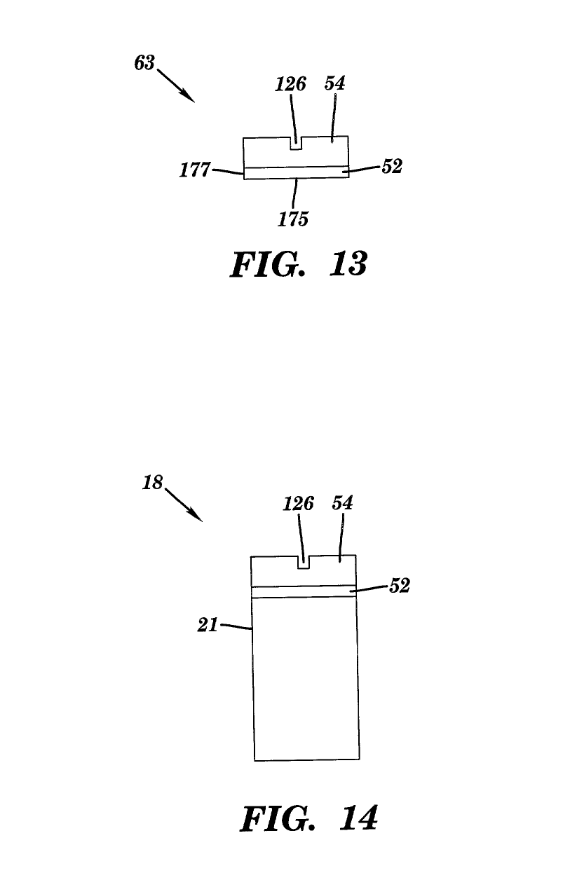

FIG. 14 depicts a front cross sectional view of, for example, a vial kit 18, comprising a vial 21 and the vial cover or septum 63 of FIG. 13. The coating layer 52 of the apparatus 63 may be an operable surface of the apparatus 63, since only coating layer 52 of the apparatus 63 contacts the vial 21, as depicted in FIG. 14. Alternatively, vials 21 may be inserted into compartments 83 in containers 80 as depicted in FIG. 5 and described in associated text supra, wherein the container 80 acts as a holder for the vials 21. When vials 21 are inserted into compartments 83 of containers 80 for use as containers of the chemicals of the present invention, the containers and the vials 21 therein may be closed using the container covers 70 by inserting the at least one plug portion 72 into the open compartments 83 of the containers 80 as depicted in FIGS. 5 and 6 and described in associated text supra.

Referring to FIGS. 10-13, it has been found that when the steps of the method 10 are followed, the coating layer material 52 is chemically bonded to the curable rubber layer 54 of for example the vial cover or septum 63. Referring to FIG. 13, the vial cover or septum 63 may be formed from uncolored, natural color, blue or other colored curable rubber and from uncolored, natural color, blue, red or other colored coating layer material, such that when the curable rubber layer 54 is covered by the coating layer 52, the color of the curable rubber layer 54 is not visible by visual inspection. A color of the curable rubber layer 54 may not be visible through the color of the coating layer 52 because the effective thickness (Tₑ) of the coating layer 52 formed by the steps of method 10 may be sufficiently thick to prevent the color of the curable rubber layer 54 from showing through the color of the coating layer 52, resulting in the color of the curable rubber 54 becoming visible by visual inspection. Therefore, as depicted in FIGS. 10-13 and described in associated text supra, visual inspection may be used to identify imperfections in a degree of covering of the curable rubber layer 54 by the coating layer 52. Hereinafter, imperfections in the degree of covering of the curable rubber layer 54 by the coating layer 52 are locations in the coating layer 52 that result from a reduction in the effective thickness (Tₑ) of the coating layer 52, such that the color of the curable rubber layer 54 may be visible by visual inspection.

Referring to FIG. 11, in an embodiment of the present invention using method 10, injecting a blue curable rubber against an etched surface 60 of a portion 49 of a red coating layer material at a temperature of from about 150° C. to about 180° C. for about 15 seconds to about 45 seconds resulted in chemically bonding the etched surface 60 of the portion 49 of the red coating layer material to the curable rubber layer 54, in accordance with the step 17 of the method 10. No visible imperfections in the degree of covering of the curable rubber layer 54 by the coating layer 52 were observed.

With respect to the method 10, the following experiment run was recorded:

(1) a mold half containing a plurality of cavities and mold half having injector for injecting a curable rubber into the cavities were preheated to 165° C.;

(2) the cavities of the mold half were covered with a sheet of PTFE having an etched surface, such that the etched surface faced the injector;

(3) 25 grams of silicone rubber was injected through the injector of the mold half against the etched surface of the sheet of PTFE, compressing a portion of the PTFE sheet into a facing cavity of the mold half at a pressure from about 200 bar to about 250 bar;

(4) the molded parts were curable using a 30 second cycle time;

(5) the molded parts were removed from the mold half; and

(6) the cycle was repeated.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for forming an apparatus, comprising:
providing a mold having an exposed surface, wherein the exposed surface includes at least one cavity;
providing a coating layer material on the exposed surface;
injecting a curable rubber into the cavity, resulting in forming the apparatus, and wherein a portion of a surface of the apparatus is an operable surface, and wherein the operable surface is the coating layer material chemically bonded to the curable rubber.

2. The method of claim 1, wherein a thickness of the coating layer includes an effective thickness.

3. The method of claim 1, wherein the effective thickness of the coating layer includes from a minimum of from about 0.1 mils to about 5 mils.

4. The method of claim 1, wherein the coating layer material includes material from a continuous roll of cast liquid polytetrafluoroethylene.

5. The method of claim 1, wherein the coating layer material is etched by plasma.

6. The method of claim 1, wherein the curable rubber material is selected from the group consisiting of silicone elastomer, organic elastomer, viton, sanoprene, and EPDM.

7. A method for forming a coating layer on a curable silicone rubber layer comprising:
providing a mold having an exposed surface, wherein the exposed surface includes at least one cavity;
providing a coating layer material on the exposed surface;
injecting the curable silicone rubber into the cavity; and
bonding the coating layer chemically to the curable silicone rubber.

8. The method of claim 7, wherein a thickness of the coating layer is an effective thickness.

9. The method of claim 7, wherein the effective thickness of the coating layer includes from a minimum of about 0.1 to about 5 mils.

10. The method of claim 7, wherein at least one face of the coating layer is etched with sodium naphthalene.

11. The method of claim 7, wherein the coating layer material is selected from the group consisting of polytetrafluoroethylene, cast liquid polytetrafluoroethylene, fluorinated ethylene propylene and aluminum foil.

12. The method of claim 7, wherein a surface of the coating layer material facing the exposed surface of the mold has been etched by plasma.

13. The method of claim 7, wherein the coating layer material includes fluorinated ethylene propylene.

14. The method of claim 7, wherein at least one face of the coating layer material has been plasma etched.

15. The method of claim 7, wherein the step of injecting into the cavity further comprises using about 100 bar to about 300 bar.

16. The method of claim 7, wherein the step of injecting into the cavity further comprises heating from about 150° C. to about 180° C.

17. An article comprising:
a coating layer chemically bonded to a curable rubber layer; wherein the coating layer has an effective thickness (Tₑ) defined as: Tₑ≧F*T, wherein F is a thinning fraction and is equal to a surface area (SAₒ) of an opening of a cavity of a mold divided by a surface area (SA_{c}) inside the cavity of said mold, and wherein T is a thickness of a coating layer material.

18. The article of claim 17, wherein the effective thickness includes from a minimum of about 0.1 mils to about 5.0 mils.

19. The article of claim 17, wherein the coating layer prevents degradation of the cured rubber layer.

20. The article of claim 17, wherein the coating layer reduces a coefficient of friction of the cured rubber layer.

21. The article of claim 17, wherein the coating layer is selected from the group consisting of polytetrafluoroethylene, cast liquid polytetrafluoroethylene, fluorinated ethylene propylene and aluminum foil.

22. The article of claim 17, wherein the coating layer chemically bonded to the curable rubber layer is an operable surface of a container cover selected from the group of covers consisting of vial covers, septa, vial pack covers and micro pack covers.

23. The article of claim 22, wherein the operable surface of the container covers seals containers, wherein the container holds samples selected from the group consisting of biotechnological, chemical and medicinal.
